(19) United States
(12) Patent Application Publication
(10) Pub. No.: US 2004/0215429 A1
(43) Pub. Date: Oct. 28, 2004

(54) Optimization on nonlinear surfaces

(76) Inventors: Nagabhushana Prabhu, West Lafayette, IN (US); Hung-Chieh Chang, Weatherford, OK (US)

Correspondence Address: Charles C Walauskas, Baniak Pine & Gannon, Suite 1200, 150 North Wacker Drive, Chicago, IL, 60606-1601, US

(21) Appl. No.: 10/476,431

(22) PCT Filed: Apr. 30, 2002
(86) PCT No.: PCT/US02/13434

Related U.S. Application Data
(60) Provisional application No. 60/287,327, filed on Apr. 30, 2001.

(51) Int. Cl. G06F 17/10

(52) U.S. Cl. 703/2

(57) ABSTRACT

The present invention is a system and method of a feasible point method, such as a canonical coordinates method, for solving non linear optimization problems. The method goes from a point to another point along a curve of a defined nonlinear surface. An objective function is determined from the plurality of points. Each point is given a value determined from the objective function. The objective function value is maximized to improve computational efficiency of a non linear optimization procedure.

### 1 FIELD OF THE INVENTION

The present invention relates to optimization algorithms used for decision-making processes and, more particularly, to using a feasible-point method, such as a canonical coordinates method, for solving nonlinear optimization problems.

### 2 BACKGROUND OF THE INVENTION

The dawning of the information age has led to an explosive growth in the amounts of information available for decision-making processes. Previously, when the amount of available information was manageably (and relatively) small, humans, with some assistance from computers, could make effective and optimal decisions. As time progressed, however, it became increasingly clear that the available computational and analytical tools were vastly inadequate to handle a changed situation in which the amount of available information became manageably larger. Consequently, decision-making processes in financial, industrial, transportation, drug and wireless industries—just to name a few—have become grossly sub optimal. Devising a situation in which the human decision-makers in such settings could make optimal decisions, coupled with the use of adequate computational and analytical tools, for these varied settings would obviously have a significant impact on both the industries involved and the modern economy.

Listed below are a few sample applications wherein the explosion in the amount of available information and the problem complexity has made it impossible for humans to make optimal decisions in real-time:

1. E-business: For commodities such as, for example, fresh produce or semiconductor components, the demand, supply and transportation costs data are available both nationally and internationally. However, the data changes practically day-to-day, making it impossible for humans to make optimal buying, selling and routing decisions;

2. Drug design: With the completion of the human genome project, it has now become possible to understand the complex network of biochemical interactions that occur inside a cell. Understanding the biochemical networks in the cell, however, involve analyzing the complex interaction among tens of thousands of nearly instantaneous reactions—a task that is beyond the human information processing capability;

3. Wireless communication: Wireless communication is a typical example of an application wherein a fixed amount of resources—for example, channels—are allocated in real-time to tasks—in this case, telephone calls. Given the large volume of communication traffic, it is virtually impossible for a human to undertake such a task without the help of a computer;

4. Airline crew scheduling: With air travel increasing, industry players need to take into account a variety of factors when scheduling airline crews. How-ever, the sheer number of variables that much be considered it too much for a human to consistently monitor and take into account; and

5. Information retrieval: Extracting relevant information from the large databases and the Internet—in which one typically has billions of items—has become a critical problem, in the wake of the information explosion. Determining information relevance, in real time, given such large numbers of items, is clearly beyond human capability. Information retrieval in such settings requires new tools that can sift through large amounts of information and select the most relevant items.

In applications such as those listed above, one is required to make optimal decisions, based on large amounts of information, subject to several constraints, during the decision-making process. For example, in the airline crew scheduling problem, the objective is to staff all the flights with crew members at the lowest possible personnel costs. The scheduling is constrained by conditions, such as, for example, the current geographic locations of the crew members (e.g., a crew member who is in New Zealand on Friday evening cannot be assigned to a flight departing from San Francisco on Saturday morning), the shifts the crew work (e.g., 3-day shifts with 2-day rest in between), crew members' flight preferences, etc. Determining the weekly schedule for all the crew members in a major U.S. airline involves computing values of nearly thirteen million variables. The optimal schedule would set values of these millions of variables in such a way as to minimine the total cost of stafing the flights while satisfying all the conditions.

We consider the equality constrained optimization problem

Maximize f(χ)

Subject to g(χ)=0 (1)

where χ ∈ R^{n+m} and f: R^{n+m}→R and g: R^{n+m}→R^{n+m} are smooth functions. Such problems are currently solved mainly using some variant of Reduced Gradient Method (RGM), Sequential Quadratic Programming (SQP) (with or without trust region constraints) or Homotopy Methods.

The SQP and homotopy methods attempt to compute a locally optimal solution using the known Lagrangian function and the optimality conditions. For instance most SQP algorithms compute, in each iteration, a Newton or Quasi-Newton step on the Lagrangian function by interpreting the Newton recurrence equation as the first order optimality condition of a related quadratic program. The Newton or Quasi-Newton step is computed, not directly, but by solving the quadratic program. The several variants of the SQP, including those that impose trust region constraints, are based on the underlying goal of extremizing the Lagrangian function.

The homotopy methods too solve constrained nonlinear equation problems (NLP) by reducing the optimization problem to a nonlinear solvability problem using the first order optimality conditions. In the case of homotopy methods, polynomial programming (polynomial constraints and objective function) has been investigated much more extensively and completely than the non-polynomial case, largely due to the Bezout's theorem for polynomials.

Both SQP and homotopy methods are infeasible-points methods in that the sequence of points generated by the methods, in general, lie outside the feasible region. Feasibility is attained only in the limit as the sequence converges to the optimal solution. There have been some attempts to design feasible-points SQP method, but such efforts are mostly focused on inequality constraints. In contrast to the SQP and homotopy methods, the reduced gradient methods are examples of the so-called feasible-points method; the sequence of points generated by the RGM lie within the feasible region.

As is well-known, the computational difficulty of a nonlinear optimization problem depends not just on the size of the problem—the number of variables and constraints—but also on the degree of nonlinearity of the objective and constraint functions. As a result, it is hard to predict with certainty before-hand whether a software package can solve a given problem to completion. Attempts to solve even simple equality constrained optimization problems using commercial software packages (such as, for example, MATLAB or GAMS) show that quite often the computation is aborted prematurely, and even when the computation does run to completion, often the returned “solutions” are infeasible.

In the presence of such instability, feasible-points methods are more desirable than the infeasible-points methods. When the optimization is aborted prematurely, the intermediate ‘solution’ in infeasible-points methods would be of no value, whereas, an intermediate solution in feasible-points methods (a) would be feasible, (b) would be an improvement over the initial solution and (c) possibly even acceptably close to optimality. One could also use the intermediate solution in feasible-points methods as the initial solution from which to resume optimization thereby ensuring that all of the prior computation contributes cumulatively to solving the problem. In addition the feasible-points methods are known to have excellent convergence properties and one does not need merit functions for their analysis. In extreme cases the objective function may not even be defined outside the feasible region making feasible-points method, not just desirable, but the only recourse. For the above reasons designing an efficient feasible-points method for equality-constrained problems is of considerable interest. In practice, however, the reduced gradient methods are exceedingly slow and numerically inaccurate in the presence of equality constraints. The drawbacks of the reduced gradient method can be traced to the enormous amounts of floating point computation that they need to perform, in each step, to maintain feasibility. These drawbacks are illustrated below.

The feasible region of (1) is typically an n-dimensional surface in R^{n+m}, n, m>0; in FIG. ?? the curved surface represents the feasible region. Let χₖ be the k^{th} feasible point of (1), generated by the reduced gradient algorithm. Let ∇f(χₖ) denote the gradient of f at χₖ. If, as shown in FIG. ??, neither ∇f(χₖ) nor II(χₖ), the projection of ∇f(χₖ) onto the plane tangent to the feasible region at χₖ, are feasible directions, then any move along ∇f(χₖ) or II(χₖ) takes the algorithm out of the feasible region. When faced with this situation, typically a nonlinear programming algorithm moves along II(χₖ) to a point such as yₖ at which the objective function value is better than at χₖ. Subsequently, the algorithm moves along the direction orthogonal to II(χₖ) to a feasible point on the constraint surface, such as χₖ₊₁.

The task of moving from an infeasible point such as yₖ to a feasible point such as χₖ+1 is both computationally expensive and a source of numerical inaccuracy. In addition, in the presence of nonlinear constraints, there is the problem of determining the optimal step size; for instance, as shown in FIG. 2, the form of the constraint surface near χₖ could greatly reduce the step-size in the projected gradient method. Certainly, by choosing χₖ+1 to be sufficiently close to χₖ it is possible to ensure feasibility of χₖ₊₁; however such a choice would lead to only a minor improvement in the objective function and would be algorithmically inefficient.

As is shown, then, none of the known methods is capable of solving the large problems arising in the real world efficiently and reliably. The infeasible-point methods—SQP and Homotopy Methods—do not confine their search to the given surface. Instead, they stray off the surface at the beginning of the computation and try to return to the surface towards the very end. This is a serious problem for the following reason: More often than not, the search for the best solution terminates prematurely. The reasons for such premature termination include memory overflow and error build-up to illegal operations (e.g., division by very small numbers, such as zero). If the surface terminates prematurely when the algorithm has strayed off the surface, the current location of the algorithm (at this point, off the surface) is useless for resuming the search. Therefore, one would need to start the search at the same point at which one started before. Repeatedly resetting the search process wastes all the computational effort invested into the aborted searches. In addition, the infeasible-point methods are known to have very poor convergence.

In contrast to the infeasible-point methods, a feasible-points method—such as RGM—conducts the search as shown in dashed lines in FIG. 2. The RGM generates a sequence of points which move closer and closer to the best solution as k goes to infinity. In a typical step, the RGM first leaves the surface. Then, in a corrective step, the algorithm returns to the surface to a different point. The corrective step—from a point off the surface to a point on the surface—is extremely expensive computationally, since it involves solving the system of given equations. As a result, the RGM method possesses much of the same disadvantages of infeasible-point methods—that is, it is both slow and numerically unstable.

Thus, whenever the feasible region is a low-dimensional differentiable manifold (surface), the problem of maintaining feasibility constitutes significant computational overheads in the RGM. These computational overheads not only slow down the algorithm, but also introduce a considerable amount numerical inaccuracy. One of the main challenges facing nonlinear optimization is to devise a method for maintaining feasibility on a general curved surface at a low computational cost.

In summary, the main problem with all of the known methods is that they do not have the mathematical ability to remain on the given surface while searching for the best solution. As a result, they stray off the given surface during the computation. Once they stray off the surface, returning to it is requires enormous amounts of computation. On the other hand, if an algorithm tries not to return to the surface until the very end then it is fraught with the risk of losing all the computation (not to mention time and effort), if terminated prematurely.

For these reasons, there is compelling economic and scientific need for a new method that can search for the best solution on the surface very fast and without every leaving the surface, as well as to overcome the above-stated disadvantages.

### 3 SUMMARY OF THE INVENTION

The problems discussed above and others, such as, for example, engineering design and reconfigurable computing, are representative examples of a large class of decision-making problems arising in business, finance, engineering, scientific and technological settings to solve which humans need to rely increasingly on decision-support systems. All the decision-support systems are based on a mathematical technique called optimization. In optimization, one seeks to determine the best (optimal) values of a (usually large) set of decision variables while satisfying user-imposed conditions on the decision variables.

Thus, in the present invention, there is disclosed a method for a general optimization problem that is capable of searching for the best solution without ever leaving the feasible surface. This method, which will be called the canonical coordinates method (CCM), goes from a point to another point along a curve on the surface as shown by the heavy line in FIG. 1. Since the method never leaves the surface:

1. At premature termination, the algorithm would be at a point on the surface from which one could resume computation. Thus, the computational effort contributes cumulatively.

2. The method described herein does not pay the heavy computational price of returning to the surface from outside the surface.

Thus, to this end, a method for improving the computational efficiency of nonlinear optimization procedure is disclosed. The method comprises the steps of, first, receiving a nonlinear surface. The nonlinear surface includes a plurality of points, wherein each of the plurality of points includes an associated value. Second, the method comprises the step of receiving an objective function which associates to each of the plurality of points an objective function value. Third, the method comprises the step of selecting one of the plurality of points to be a reference point. Finally, the method comprises the step of maximizing the objective function value. This maximization is preferably realized by the sub-steps of, first, computing a direction, at the reference point such that the associated value of a point in proximity to the reference point and on a line passing through the reference point in the improving direction is greater than the associated value of the reference point; second, computing a curve that lies entirely on the nonlinear surface such that the tangent to the curve at the reference point coincides with the computed direction; third, determining the point along curve at which the objective function value attains a value higher than that at the reference point; and fourth adjusting the reference point to be the point resulting from the above determining step.

These and other features and advantages of the present invention will be further understood upon consideration of the following detailed description of an embodiment of the present invention, taken in conjunction with the accompanying drawings.

### 4 BRIEF DESCRIPTION OF THE DRAWINGS

FIG. 1 illustrates an example of a projected gradient method on a curved constraint surface; and

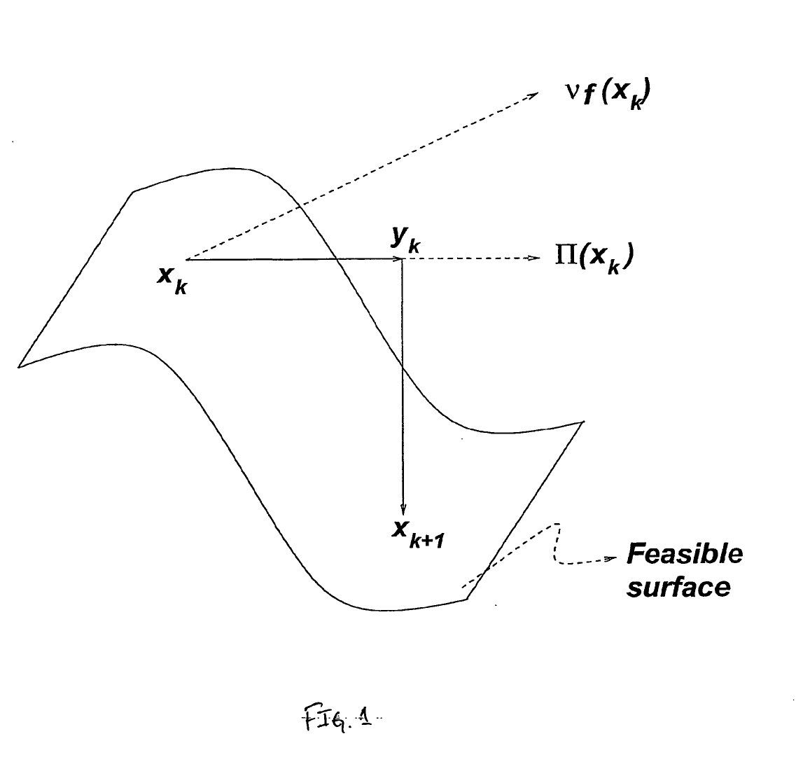

FIG. 2 illustrates a small step size in a projected gradient method.

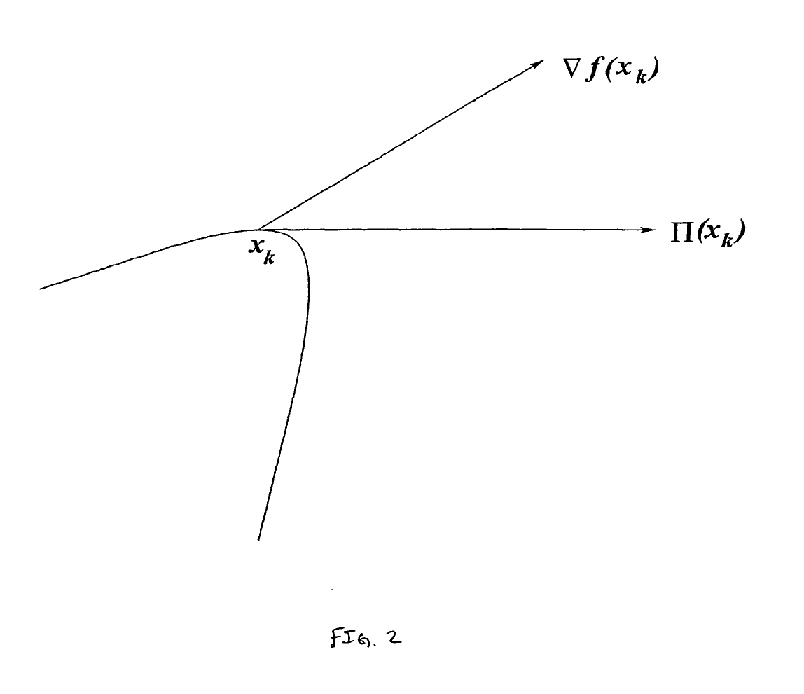

### DETAILED DESCRIPTION OF THE PRESENTLY PREFERRED EMBODIMENTS

As discussed above, feasible-points methods have several appealing advantages over infeasible-points methods for solving equality-constrained nonlinear optimization problems. The known feasible-points methods however often solve large systems of nonlinear constraint equations in each step in order to maintain feasibility. Solving nonlinear equations in each step not only slows down the algorithms considerably, but also the large amount of floating-point computation involved introduces considerable numerical inaccuracy into the overall computation. As a result, the commercial software packages for equality-constrained optimization are slow and not numerically robust. What is presented is a radically new approach to maintaining feasibility—the Canonical Coordinates Method (CCM). The CCM, unlike previous methods, does not adhere to the coordinate system used in the problem specification. Rather, as the algorithm progresses, the CCM dynamically chooses, in each step, a coordinate system that is most appropriate for describing the local geometry around the current iterate, or equation being solved. By dynamically changing the coordinate system to suit the local geometry, the CCM is able to maintain feasibility in equality-constrained nonlinear optimization without having to solve systems of nonlinear equations.

To describe the notion of canonical coordinates we consider the following simple example:

Min χ⁶−y⁸

S.T. χ²+y²+z²=1 (2)

As one can verify, when we try to solve this problem using the fmincon routine (for constrained minimization) in MATLAB 6.1, starting at the initial point χ₀=

$$[ \frac{1}{\sqrt{2}} , \frac{1}{2} , \frac{1}{2} ]$$

the optimization gets terminated prematurely with the message that no feasible solution could be found. The equality constraint in the NLP represents a 2-dimensional surface. As we discussed above, whenever the dimension of the feasible region is less than that of the ambient space, the reduced-gradient method has to repeatedly solve nonlinear equations to maintain feasibility and it does so on this simple NLP as well. It is noteworthy that a commercial NLP solver cannot solve a simple problem such as (2), which highlights the seriousness of the problem of maintaining feasibility.

It turns out that the difficulty in this case arises from inappropriate coordinates used in the problem specification. If we apply the cartesian-to-spherical coordinate transformation (χ, y, z) [symbol] (θ, φ), χ=sin(θ) cos(φ), y=sin(θ) sin(φ), z=cos(θ), to this problem then in the transformed coordinates the problem becomes,

Min sin⁶(θ) cos⁶(φ)−cos⁸(θ)

S.T. 0≦θ≦π

0≦φ≦2π

In the transformed problem the equality constraint has disappeared and the transformed feasible region, unlike in the original problem, is a full-dimensional subset of the θ-φ plane. Since the transformed feasible region is full-dimensional, maintaining feasibility is a trivial matter in the transformed coordinates. Not surprisingly, when we use the fmincon to solve the transformed problem, starting at the initial point (1.0472, 0.6155)—which corresponds to

$$[ \frac{1}{\sqrt{2}} , \frac{1}{2} , \frac{1}{2} ]$$

—we get an optimal solution (θ*, φ*)=(0, 1.6155)—which corresponds to (χ, y, z)=(0, 0, 1)—after two iterations. (θ, φ) is clearly a preferred or canonical coordinate system for the problem in the sense that in the (θ, φ) coordinates the problem assumes a simple form. The difficulties in maintaining feasibility, at least in this problem then, appears to be an artifact of the inappropriate (χ, y, z) coordinate system rather than an inherent feature of the problem itself.

The example motivates the following definition.

Definition 1 Consider a nonlinear optimization of the form

Min f(χ)

S.T. E(χ)=0; χ∈R^{n+m}; E:R^{n+m}→R^{m}

I(χ)≦0; I:R^{n+m}→R^{P} (3)

whose feasible region is an n-dimensional manifold. If there exists a coordinate transformation (χ₁, . . . , χₙ₊ₘ) [symbol] (y₁, . . . , yₙ) such that (3) written in transformed coordinates has the form

Min \overline{f}(y)

S.T. \overline{I}(y)≦0 \overline{I}:Rⁿ→R^{q} (4)

where \overline{I}(y)≦0 represents an n-dimensional subset of Rⁿ, then y is called a canonical coordinate system for the problem (3).

If an algorithm can determine a canonical coordinate system for a general NLP then the problem of maintaining feasibility would be made trivial by a transformation to the canonical coordinate system. However, as a simple example in the next section shows, a low-dimensional curved surface may not have a canonical coordinate system.

While a curved surface may not admit a canonical coordinate system that covers the whole surface, it turns out that we can always find a canonical coordinate patch to cover a local neighborhood of a point on the curved surface. The Canonical Coordinates Method (CCM) presented in this paper constructs a sequence of overlapping canonical coordinate patches on the given feasible surface as the algorithm progresses. The CCM is a departure from the other feasible-points methods in that it does not adhere to the coordinate system used in the problem formulation. Instead, in each step it chooses a different coordinate system that is most appropriate to describe the local geometry around current iterate. By choosing in each step, a canonical coordinate system for a local neighborhood around the current iterate the CCM is able to maintain feasibility at a low computational cost. Moreover, the CCM is still sufficiently powerful and is able to solve problems that commercial NLP solvers cannot. Additionally, the numerical computation in the CCM can be made considerably more robust and efficient, in particular, for large numbers of constraints.

Thus, preferably, CCM is an approach to maintaining feasibility on an arbitrary curved surface. Recall that, given a general nonlinear surface, one cannot in general coordinatize the entire surface with a single canonical coordinate system. The preceding statement is easily justified with a simple example. Consider a two-dimensional sphere S. If one could find a canonical coordinate system that covers all of S, then there must be a differentiable bijection from S to R². Let φ be such a bijection. Let A and B be the two hemispheres of S, whose intersection is the equator E. Let A⁰=A\E and B⁰=B\E be the two open hemispheres. φ(E) is a closed curve in R² and the complement of φ(E) comprises two disjoint open sets in R² (Jordan Curve Theorem)—φ(⁰) and R²\φ(A). But A is a compact set and φ a homeomorphism. Hence φ(A) is also a compact set. φ(A⁰) ⊂ φ(A) and hence φ(A⁰) is bounded. By the same reasoning φ(B⁰) is also bounded. But R²\φ(E)=φ(A⁰) ∪ φ(B⁰) is an unbounded set. The contradiction proves that the map W cannot exist.

Since an n-dimensional nonlinear surface M cannot, in general, be covered by a single coordinate system, the most we can do is

1. divide M into overlapping open neighborhoods M₁, . . . , Mᵣ such that M=M₁ ∪M₂ ∪. . . ∪ Mᵣ and

2. for eac open neighborhood Mᵢ, 1≦i≦r, choose a canonical coordinate system, θ:Mᵢ→Ω ⊂ Rⁿ where Ω is an open subset of Rⁿ. The problem

Min f(x)

S.T. x∈M

restricted to the patch Mᵢ and formulated in terms of the canonical coordinates becomes

Min \hat{f}ᵢ(θ⁽ⁱ⁾)

S.T. θ⁽ⁱ⁾∈Ω⊂Rⁿ (5)

where θ⁽ⁱ⁾≡(θ₁⁽ⁱ⁾(χ), . . . , θₙ⁽ⁱ⁾(χ)), f(x)=\hat{f}ᵢ(θ⁽ⁱ⁾(x)). Since Ω is an open subset of Rⁿ, feasibility is easily maintained in the transformed problem (5).

The above approach of coordinatizing an arbitrary curved surface with overlapping coordinate patches for ease of maintaining feasibility has not been investigated before, to the best of our knowledge. In the following discussion we address the problem of computing the desired canonical coordinate systems algorithmically.

Consider the optimization problem

max{f(ξ)|φ(ξ)=0; ξ∈R^{n+m};φ:R^{n+m}→R^{m}; f:R^{n+m}→R}. (6)

Assume that the feasible region F: φ(ξ)=0 is an n-dimensional manifold. CCM computes a sequence of points ξ⁽¹⁾, ξ⁽²⁾, . . . →ξ*∈F such that f (ξ⁽¹⁾)≦f(ξ⁽²⁾)≦. . . . In order to compute ξ^{(k+1)} ∈F, given ξ^{(k)} ∈ F, the CCM determines an open neighborhood U^{(k)} of ξ^{(k)} and a em of canonical coordinates ψ^{(k)}: U^{(k)}→B(ρ^{(k)}, χ^{(k)}) ⊂ Rⁿ, where B(ρ^{(k)},χ^{(k)}) is a ball of radius ρ^{(k)}>0 centered at χ^{(k)}. (We'll use ξ to label the coordinates of the original problem and χ to label the canonical coordinates.) Our first task then is to determine ψ^{(k)} and ρ^{(k)}. We devise ψ^{(k)} using the implicit function theorem as described below. Although the variables of the problem are all real, in discussing the implicit functions and the domain of analyticity of implicit functions it is necessary to migrate to Cⁿ. In order to meaningfully carry out Taylor expansion of the implicit functions, as we will later, it is necessary to know that the implicit functions are analytic in the domain of interest. Guaranteeing analyticity in real space is considerably harder—if at all possible—than in the complex space. Hence, in the following discussion on implicit functions and their domains of analyticity, we migrate to complex space whenever necessary. The conclusions drawn in complex space remain valid when we restrict the discussion to its real subspace, that we are interested in.

Implicit Function Theorem: Let φᵢ (χ, z), i=1, . . . , m be analytic functions of (χ, z) near a point (χ₀, z₀) ∈Cⁿ×C^{m}. Assume that φᵢ(χ₀, z₀)=0, i=1, . . . , m and that

$$det ( J ( \frac{ϕ}{z} ) ) ≡ det ( \begin{matrix}\frac{\partial {ϕ}_{1}}{\partial {z}_{1}} & ⋯ & \frac{\partial {ϕ}_{1}}{\partial {z}_{m}} \\ ⋮ & & ⋮ \\ \frac{\partial {ϕ}_{m}}{\partial {z}_{1}} & ⋯ & \frac{\partial {ϕ}_{m}}{\partial {z}_{m}}\end{matrix} ) \neq 0$$

at (χ₀, z₀). Then the system of equations φ(χ, z)=0 has a unique analytic solution z(χ) in a neighborhood U of χ₀and z(χ₀)=z₀.

Partitioning the variables (ξ₁^{(k)}, . . . , ξₙ₊ₘ^{(k)}) into (χ^{(k)}, z^{(k)}), χ^{(k)} ∈ Rⁿ, z^{(k)} ∈R^{m}, such that det (J (φ, z)|_{(χ}_{^{(k)}}_{,z}_{^{(k)}}₎≠0, and using the implicit function theorem we can write zⱼ=gⱼ(χ), j=1, . . . , m, as functions of (χ₁, . . . , χₙ) in an open ball B(ρ^{(k)},χ^{(k)}) ⊂ Rⁿ centered at χ^{(k)}. Setting F(χ)≡f(χ,g₁(χ), g₂(χ), . . . , gₘ(χ)), we can-rewrite NLP (6) as

max F(χ)

S.T. χ∈B(ρ^{(k)},χ^{(k)}). (7)

The feasible region of (7) is an open ball in Rⁿ which makes the task of maintaining feasibility straightforward. In order to solve (7) efficiently however (a) we need to be able to compute gᵢ(χ)—explicitly or implicitly—to required accuracy and (b) we need to determine the radius ρ^{(k)} of the open ball. Although implicit function theorem is an old classical result, surprisingly and to the best of our knowledge, estimates of the radius of convergence of the implicit functions have not been reported in the literature. In the following theorem we derive the first such bound for the size of the implicit function neighborhood. Specifically the following theorem derives a bound for the case of one nonlinear equation in n+1 variables. We expect that the argument can be extended in a straightforward manner to a system of m equations in m+n variables, m, n>0.

Theorem 1 Let φ(χ, z) be an analytic function of n+1 complex variables, χ∈ Cⁿ,

$$z ∈ C . Let \vert \frac{\partial ϕ ( 0 , 0 )}{\partial z} \vert = a > 0 ,$$

and let |φ(0, z)|≦M on D where D={(χ,z)|∥(x,z)∥≦R}. Then z=g(χ) is an analytic function of χ in the ball

$$‖ x ‖ \leq \frac{1}{M} ( ar - \frac{{Mr}^{2}}{{R}^{2} - rR} ) where r = min ( \frac{R}{2} , \frac{a {R}^{2}}{2 M} )$$

Proof: Since φ(χ, z) is an analytic function of complex variables, by the Implicit Function Theorem z=g(χ) is an analytic function in a neighborhood U of (0, 0). To find the domain of analyticity of g we first find a number r>0 such that φ(0, z) has (0,0) as its unique zero in the disc {(0, z): |z|≦r}. Then we will find a number s>0 so that φ(χ, z) has a unique zero (χ, g(χ)) in the disc {(χ, z): |z|≦r} for |χ|≦s with the help of Roche's theorem. Then we show that in the domain {χ:∥χ∥s} the implicit function z=g(χ) is well defined and analytic.

Note that if we expand the Taylor series of the function (p with respect to the variable z, we get

$$ϕ ( 0 , z ) = \frac{\partial ϕ ( 0 , 0 )}{\partial z} + {\sum }_{j = 2}^{∞} \frac{\frac{{\partial }^{j} ϕ}{\partial {z}^{j}} ( 0 , 0 ) {z}^{j}}{j !} .$$

Let us assume that

$$\vert \frac{\partial ϕ}{\partial z} ( 0 , 0 ) \vert = a > 0. \vert ϕ ( 0 , z ) \vert \leq M$$

on D where D={(χ,z) ∥(χ, z)∥≦R}. Then by Cauchy's estimate, we have

$$\vert \frac{\frac{{\partial }^{j} ϕ}{\partial {z}^{j}} ( 0 , 0 ) {z}^{j}}{j !} \vert \leq \frac{j !}{{R}^{j}} M .$$

This implies that

$$\begin{matrix}\vert ϕ ( 0 , z ) \vert \geq a \cdot \vert z \vert - {\sum }_{j = 2}^{∞} {M ( \frac{z}{R} )}^{j} \\ = a \cdot \vert z \vert - \frac{M {\vert z \vert}^{2}}{{R}^{2} - \vert z \vert R} .\end{matrix} \qquad ( 8 )$$

Since our goal is to have |φ(0, z)|>0, it is sufficient to have

$$a \cdot \vert z \vert - \frac{M {\vert z \vert}^{2}}{{R}^{2} - \vert z \vert R} > 0.$$

Dividing both sides by |z| we get

$$\begin{matrix}a > \frac{M \vert z \vert}{{R}^{2} - \vert z \vert R} ⇔ a ( {R}^{2} - \vert z \vert R ) - M \vert z \vert > 0 ⇔ \vert z \vert ( aR + M ) < {aR}^{2} \\ ⇔ \vert z \vert < \frac{a {R}^{2}}{aR + M} = \frac{R}{1 + \frac{M}{aR}} .\end{matrix}$$

We choose

$$\begin{matrix}r = min ( \frac{R}{1 + 1} , \frac{R}{\frac{2 M}{aR} + \frac{2 M}{aR}} ) \\ = min ( \frac{R}{2} , \frac{{aR}^{2}}{2 M} ) .\end{matrix}$$

To compute s we need Roche's Theorem.

Roche's Theorem: Let h₁ and h₂ be analytic on the open set U ⊂ C, with neither h₁ nor h₂ identically 0 on any component of U. Let γ be a closed path in U such that the winding number n(γ, z)=0, ∀z ¢ U. Suppose that

|h|(z)−h₂(z)|<|h₂(z)|, ∀z∈γ

Then n(h₁ ∘ γ, 0)=n(h₁ ∘ γ, 0). Thus h₁ and h₂ have the same number of zeros inside γ, counting multiplicity and index.

Let h₁ (z):=φ(0, z), and h₂:=φ(χ, z). We can treat χ as a parameter, so our goal is to find s>0 such that if |χ|<s, then

|φ(0, z)−φ(χ, z)|<|φ(0, z)|∀z ∈ γ,

where γ={z:|z|=r}. We know |φ(0, z)−φ(χ, z)|<Ms if γ ⊂ D and we also have

$$\vert ϕ ( 0 , z ) \vert > a \cdot \vert z \vert - \frac{M {\vert z \vert}^{2}}{{R}^{2} - \vert z \vert R}$$

from (8). It is sufficient to have

$$M s < a \cdot \vert z \vert - \frac{M {\vert z \vert}^{2}}{{R}^{2} - \vert z \vert R} .$$

On γ, we know |z|=r, and therefore as long as

$$s < \frac{1}{M} ( ar - \frac{M {r}^{2}}{{R}^{2} - r R} ) ,$$

we can apply the Roche's theorem and guarantee that the function φ(χ, z) has a unique zero, call it g(χ). That is, φ(χ, g(χ))=0 and g(χ) is hence a well defined function of χ.

Note that in the Roche's theorem, the number of zeros includes the multiplicity and index. Therefore all the zeros we get are simple zeros since (0, 0) is a simple zero for φ(0,z). This is because φ(0,0)=0 and φ_{z}(0,0)≠0. Hence we can conclude that for any χ such that |χ|<s, we can find a unique g(χ) so that φ(χ,g(χ))=0 and φ_{z}(χ,g(χ))≠0.

Recall that our objective is, given the optimization problem (6) and a feasible solution ξ^{(k)} satisfying φ(ξ^{(k)})=0, to compute ξ^{(k+1)} also satisfying φ(ξ^{(k+1)})=0 such that f(ξ^{(k)})≦f(ξ^{(k+1)}). Given ξ^{(k)}, CCM computes ξ^{(k+1)} in three steps:

(a) partition ξ^{(k)}=(χ^{(k)}, z^{(k)}) where χ^{(k)} are the canonical coordinates and reformulate (6) in terms of the canonical coordinates as (7).

(b) Solve (7) and obtain χ^{(k+1)} as the solution.

(c) Use the implicit functions g₁, . . . , gₘ to construct ξ^{(k+1)}=(χ^{(k+1)}, g(χ^{(k+1)})).

In the following discussion we address steps (b) and (c) above.

One can solve (6) using any of the feasible-points methods for inequality-constrained problems. All such methods involve computing the implicit functions explicitly or implicitly. We elaborate on the issues involved in computing the implicit functions in the context of one of the feasible-points methods—gradient search The discussion is easily adapted to other feasible-points methods.

Given the j^{th} iterate y^{(j)} ∈ B(ρ^{(k)},χ^{(k)}), the gradient search algorithm computes y^{(j+1)} by solving the 1-dimensional optimization problem

max α(t):=F(y^{(j)}+t\vec{D}^{(j)}, g(y^{(j)}+t\vec{D}^{(j)}))

S.T. y^{(j)}+t\vec{D}^{(j)}∈B(ρ^{(k)}, χ^{(k)})

where \vec{D}^{(j)}:=∇F(y^{(j)}, g(y^{(j)})). The constraint y^{(j)}+t\vec{D}^{(j)} ∈B(ρ^{(k)}, χ^{(k)}) is equivalent to t₁≦t≦t₂ for some t₁, t₂ ∈ R. Therefore the 1-dimensional optimization problem can be rewritten as

max α(t)

S.T. t₁≦t≦t₂ (9)

NLP 9 can be solved using any of the line search procedures. While the different line search procedures differ considerably from one another, all of them involve computing either α(t) and/or its derivatives at several values of t ∈ (t₁, t₂). Computing α(t) involves computing g(y^{(j)}+t\vec{D}^{(j)})) and hence the efficiency of the line search is determined to a large extent by the efficiency with which we can compute g. In the following discussion we discuss two approaches to computing g efficiently: (a) Taylor approximation approach and (b) differential equation approach.

Taylor approximation method: Since the implicit function gᵢ(χ); i=1, . . . , m is analytic in a neighborhood of χ^{(k)}, we could expand gᵢ(χ) in a Taylor series as

$$\begin{matrix}{g}_{i} ( x ) = {g}_{i} ( {x}^{( k )} ) + \\ {\sum }_{1 \leq {j}_{1} + … + {j}_{n} = j \leq p} \frac{{\partial }^{j} {g}_{i} ( {x}^{( k )} )}{{\partial }^{{j}_{1}} {x}_{1} … {\partial }^{{j}_{n}} {x}_{n}} \frac{{( {x}_{1} - {x}_{1}^{( k )} )}^{{j}_{1}}}{{j}_{1} !} ⋯ \frac{{( {x}_{n} - {x}_{n}^{( k )} )}^{{j}_{n}}}{{j}_{n} !} + \\ {\sum }_{{j}_{1} + … + {j}_{n} = j = p + 1} \frac{{\partial }^{j} {g}_{i} ( {η}^{( k )} )}{{\partial }^{{j}_{1}} {x}_{1} … {\partial }^{{j}_{n}} {x}_{n}} \frac{{( {x}_{1} - {x}_{1}^{( k )} )}^{{j}_{1}}}{{j}_{1} !} ⋯ \frac{{( {x}_{n} - {x}_{n}^{( k )} )}^{{j}_{n}}}{{j}_{n} !}\end{matrix} \qquad ( 10 )$$

where η^{(k)} ∈ [χ, χ^{(k)}]. The last term in the Taylor expansion above is the error in approximating the function by a degree p polynomial. The computation of the approximating polynomial as well as the error term requires the computation of the partial derivatives of gᵢ of arbitrary order. We observe that φᵢ(χ, z)=0, i=1, . . . , M. Differentiating with respect to χₖ we have

$$\begin{matrix}0 = \frac{\partial {ϕ}_{i}}{\partial {x}_{k}} + {\sum }_{j = 1}^{m} \frac{\partial {ϕ}_{i}}{\partial {z}_{j}} \cdot \frac{\partial {g}_{j}}{\partial {x}_{k}} \\ = {( \frac{\partial ϕ}{\partial x} )}_{ik} + {[ J ( ϕ , z ) ( \frac{\partial g}{\partial x} ) ]}_{ik} \\ where \\ \begin{matrix}( \frac{\partial ϕ}{\partial x} ) = ( \begin{matrix}\frac{\partial {ϕ}_{1}}{\partial {x}_{1}} & ⋯ & \frac{\partial {ϕ}_{1}}{\partial {x}_{n}} \\ ⋮ & & ⋮ \\ \frac{\partial {ϕ}_{m}}{\partial {x}_{1}} & ⋯ & \frac{\partial {ϕ}_{m}}{\partial {x}_{n}}\end{matrix} ) ; & ( \frac{\partial g}{\partial x} ) = ( \begin{matrix}\frac{\partial {g}_{1}}{\partial {x}_{1}} & ⋯ & \frac{\partial {g}_{1}}{\partial {x}_{n}} \\ ⋮ & & ⋮ \\ \frac{\partial {g}_{m}}{\partial {x}_{1}} & ⋯ & \frac{\partial {g}_{m}}{\partial {x}_{n}}\end{matrix} )\end{matrix}\end{matrix}$$

Since det (J (φ, z))≠0, we have

$$( \frac{\partial g}{\partial x} ) = - {[ J ( ϕ , z ) ]}^{- 1} ( \frac{\partial ϕ}{\partial x} ) \qquad ( 11 )$$

To obtain higher derivatives of g, we differentiate (11). We derive the expression for second derivative below; calculation of higher derivatives is similar. To obtain the second derivative note that

$$0 = \frac{\partial }{\partial {x}_{k}} [ {J ( ϕ , z ) [ J ( ϕ , z ) ]}^{- 1} ] = {\frac{\partial J ( ϕ , z )}{\partial {x}_{k}} [ J ( ϕ , z ) ]}^{- 1} + J ( ϕ , z ) \frac{\partial {[ J ( ϕ , z ) ]}^{- 1}}{\partial {x}_{k}}$$

which implies that

$$\frac{\partial {[ J ( ϕ , z ) ]}^{- 1}}{\partial {x}_{k}} = - {{[ J ( ϕ , z ) ]}^{- 1} [ \frac{\partial J ( ϕ , z )}{\partial {x}_{k}} ] [ J ( ϕ , z ) ]}^{- 1} \qquad ( 12 )$$

Observe that

$$\frac{\partial J ( ϕ , z )}{\partial {x}_{k}} = \frac{\partial J ( ϕ , z )}{\partial {z}_{i}} \frac{\partial {g}_{i}}{\partial {x}_{k}} \qquad ( 13 )$$

We assume we know the closed form expressions for φ(χ, z) and

$$\frac{\partial {g}_{i}}{\partial {ϰ}_{k}}$$

can be computed using (11). Differentiating (11) and using (12) and (13) we have

$$\begin{matrix}\frac{\partial }{\partial {x}_{k}} ( \frac{\partial g}{\partial x} ) = - \frac{\partial {[ J ( ϕ , z ) ]}^{- 1}}{\partial {x}_{k}} ( \frac{\partial ϕ}{\partial x} ) - {[ J ( ϕ , z ) ]}^{- 1} \{ \frac{\partial }{\partial {x}_{k}} ( \frac{\partial ϕ}{\partial x} ) \} \\ = {{[ J ( ϕ , z ) ]}^{- 1} [ \frac{\partial J ( ϕ , z )}{\partial {z}_{i}} \frac{\partial {g}_{i}}{\partial {x}_{k}} ] [ J ( ϕ , z ) ]}^{- 1} ( \frac{\partial ϕ}{\partial x} ) - \\ {[ J ( ϕ , z ) ]}^{- 1} \{ \frac{\partial }{\partial {x}_{k}} ( \frac{\partial ϕ}{\partial x} ) \}\end{matrix} \qquad ( 14 )$$

Higher derivatives of g can be computed by applying the above calculation recursively. The accuracy of the Taylor approximation can be estimated by estimating the error term in (10). In general, the accuracy increases with the order of approximation (the number of Taylor terms we compute) and with the decreasing separation between χ^{(k)} and χ. In the actual implementation one should adopt the following trust-region-like approach to implicit function computation: if the error term is unacceptably large either increase the order of approximation or decrease the trust-region over which to use the Taylor expansion. The Taylor approximation approach would be efficient whenever a low order approximation is reasonably accurate. If one is required to either compute a high order approximation or reduce the step size in order to keep the error term small, then it would be more efficient to use the differential equation approach described below.

Differential equation approach: Consider the point ξ^{(k)}=(χ^{(k)}, g(χ^{(k)})) ∈ F, where g:Rⁿ→R^{m} is the (vector) implicit function. The above discussion shows that we can compute ξ^{(k+1)} ∈ F by solving (7). In order to solve (7) using the gradient search we repeatedly perform line search along the gradient direction. Let

\vec{D}^{(k)}≡∇F(χ^{(k)}).

\vec{D}^{(k)} is easily computed using chain rule.

$$\frac{\partial F}{\partial {x}_{j}} = \frac{\partial f}{\partial {x}_{j}} + {\sum }_{i = 1}^{m} \frac{\partial f}{\partial {z}_{i}} \frac{\partial {g}_{i}}{\partial {x}_{j}}$$

Substituting the expression for

$$\frac{\partial {g}_{i}}{\partial {x}_{j}}$$

from (11) we obtain the gradient of F. Then line search along the gradient direction is equivalent to solving the 1-dimensional problem

max α(t):=F(χ^{(k)}+tD^{(k)}, z(t)) (15)

Observe that in we do not need to know the size of the implicit function explicitly, which is a big advantage of the differential equations approach. In order to solve (15) we need to evaluate the function F and hence the function z at various values of positive t. We observe that φᵢ(χ^{(k)}+tD^{(k)}, z(t))=0, i=1, . . . , m. Denote \vec{D}=(D₁, . . . , Dₙ). If we differentiate φᵢ with respect to t, we will get a system of equations:

$${D}_{1} \frac{\partial {φ}_{i}}{\partial {x}_{1}} + ⋯ + {D}_{n} \frac{\partial {φ}_{i}}{\partial {x}_{n}} + {\sum }_{j = 1}^{m} \frac{\partial {φ}_{i}}{\partial {z}_{j}} \cdot \frac{ⅆ {z}_{j}}{ⅆ t} = 0 , i = 1 , ⋯ , m .$$

Thus the values of z(t) can be found by solving the following system of initial value problems:

$$\{ \begin{matrix}z ( 0 ) = g ( {x}^{( k )} ) \\ ⟨ \vec{D} , \frac{\partial {φ}_{i}}{\partial x} ⟩ + {\sum }_{j = 1}^{m} \frac{\partial {φ}_{i}}{\partial {z}_{j}} \cdot \frac{ⅆ {z}_{j}}{ⅆ t} = 0 , i = 1 , ⋯ , m .\end{matrix} \qquad ( 16 )$$

There are well-known methods available for solving such systems.

We can compute g(χ^{(k)}+t\vec{D}^{(k)}) and hence α(t) in (15) using either of the above two approaches. Hence we can solve (15) using a line search to compute an optimal t* ∈ [t₁, t₂]. The ∈^{(k+1)} is computed as ξ^{(k+1)}=(χ^{(k)}+t*\vec{D}^{(k)}, g(χ^{(k)}+t*\vec{D}^{(k)})), where we could again use either the Taylor approximation method or the differential equation method to compute g(χ^{(k)}+t*\vec{D}^{(k)}).

The numerical approximations involved in computing the implicit function g, could cause ξ^{(k+1)} to lie close to but not exactly inside the feasible region. If ξ^{(k+1)} is found to be infeasible, one could use Newton's method, starting at ξ^{(k+1)} to compute a corrected ξ^{(k+1)} satisfying φ(ξ^{(k+1)})=0 to any desired accuracy.

During the line search above, we either compute a 1-dimensional local maximum χ^{(k+1)}—which we call a regular iterate—or terminate the line search for one of two reasons to get a singular iterate.

1. The line search reaches the boundary of the domain of analyticity in the Taylor approximation method, or

2. the differential equation encounters a singularity.

The distinction between regular and singular iterates is important and will be examined in greater detail in the proof of convergence presented in the next section. We summarize the discussion above in the following CCM algorithm for solving the general nonlinear program (6).

CCM Algorithm:

INPUT: The nonlinear program

max{f(ξ)|g(ξ)=0; ξ∈R^{n+m}; g :R^{n+m}→R^{m}; f :R^{n+m}→R}. and a feasible point ξ⁰ satisfying g(ξ⁰)=0.

OUTPUT: A critical point ξ* of f satisfying g(ξ*)=0.

1. Partition ξ⁰ into ξ⁰32 (χ⁰,z⁰) such that det (J(φ,z)|_{(χ}^{₀}_{,z}^{₀}₎)≠0.

2. For i=1, . . . m, j=1, . . . , m and k=1, . . . , n, calculate the following partial derivatives at the point p=(χ⁰, z⁰):

$$\frac{\partial f}{\partial {x}_{k}} , \frac{\partial f}{\partial {z}_{j}} , \frac{\partial {φ}_{i}}{\partial {x}_{k}} , and \frac{\partial {φ}_{i}}{\partial {z}_{j}} .$$

3. Calculate the m×n matrix

$${( \frac{\partial {g}_{j}}{\partial {x}_{k}} )}_{jk} = - {( \frac{\partial {φ}_{i}}{\partial {z}_{j}} )}_{ij}^{- 1} {( \frac{\partial {φ}_{i}}{\partial {x}_{k}} )}_{ik} .$$

Find the gradient direction

$$\vec{D} = ( \frac{\partial F}{\partial {x}_{1}} , ⋯ , \frac{\partial F}{\partial {x}_{n}} ) ,$$

where

$$\frac{\partial F}{\partial {x}_{k}} = \frac{\partial f}{\partial {x}_{k}} {\sum }_{j = 1}^{m} \frac{\partial f}{\partial {z}_{j}} {( \frac{\partial {g}_{j}}{\partial {x}_{k}} )}_{jk} , k = 1 , ⋯ , n .$$

4. Perform line search along the ray through χ⁰ with the direction \vec{D}. That is, find a 1-dimensional local optimum of

\hat{F}(t):=f(χ⁰+t\vec{D}, z₁(t), . . . , zₘ(t)) t>0.

To do so, one needs to solve for z(t), which can be done by solving the following system of ordinary differential equations:

$$\{ \begin{matrix}z ( 0 ) = {z}^{0} \\ ⟨ \vec{D} , \frac{\partial {φ}_{i}}{\partial x} ⟩ + {\sum }_{j = 1}^{m} \frac{\partial {φ}_{i}}{\partial {z}_{j}} \frac{ⅆ {z}_{j}}{ⅆ t} = 0 , i = 1 , ⋯ , m .\end{matrix} \qquad ( 17 )$$

Set χ*←χ⁰+t*\vec{D}.

5. Compute

zⱼ* :=gⱼ(χ*)j=1, . . . ,m

using the Taylor polynomial approximation followed by an application of Newton's method, or by solving the above system of ODE's at t=t*.

6. If ∇f(χ*, z*)≈0, then we have found a critical point. Otherwise, replace (χ⁰, z⁰) by (χ*, z*), and repeat the whole procedure.

In this section we present a proof of the convergence of the CCM Algorithm described in the previous section. We start with some terminology. An iterate (χ^{(k)}, g (χ^{(k)})) is said to be regular if it is obtained as a 1-dimensional local optimum in Step 4 (line search) and singular if it is obtained by terminating the line search as a result of getting too close to the boundary of the domain where the implicit function is valid or as a result of encountering a singularity in the differential equations approach. We will show in the following subsection that our algorithm will approach a critical point when there is a unique limit point and there are only finitely many singular iterates. We also show the convergence when there are more than one limit point no matter how many singular iterates we get. In the subsection after that, we will prove the result when there are infintely many singular iterations. Let us suppose a point pk is found at the k-th iteration.

Lemma 1 If p is the unique limit point of {pₖ}ₖ₌₁^{∞} and that there are at most finitely many singular iterates, then p is a critical point.

Proof: We can find a neighborhood U of p so that p is away from ∂U, the boundary of U. Suppose det(J(φ, z))≠0 in U, and F(χ):=f(χ,g(χ)) where z=g(χ)≡(g₁(χ), . . . , gₘ(χ)) in U. Denote p=(\overline{p},g(\overline{p})), and pₖ=(\overline{P}ₖ, g(\overline{p}ₖ)). Because

$$∇ F := ( \frac{\partial F}{\partial {x}_{1}} , ⋯ , \frac{\partial F}{\partial {x}_{n}} )$$

is continuous in V:={χ, (χ, g(χ)∈ U}, for any ∈>0 we can find δ>0 so that, for any χ, y ∈ B_{δ}(\overline{p}), we have

∥∇F(χ)−∇F(y)∥<∈.

Since p is the unique limit point, there exists a K>0 such that

\overline{p}ₖ∈B_{δ}(\overline{p}), ∀k≧K.

Let ∇F(\overline{p}ₖ):=cₖ\vec{D}ₖ, where∥\vec{D}ₖ∥=1,k=1, . . . , n. We know that \overline{p}ₖ₊₁ is a 1-dimensional local optimum along the line through \overline{p}ₖ with direction Dₖ. This means that the directional derivative of F at \overline{p}ₖ₊₁ is 0 along \vec{D}ₖ. That is,

<\vec{D}ₖ,\vec{D}ₖ₊₁>=0

Then for k≧K, we have

<∇F(\overline{p}ₖ)−∇F(\overline{p}ₖ₊₁), \vec{D}ₖ>=<cₖ\vec{D}ₖ−cₖ₊₁ \vec{D}ₖ₊₁, \vec{D}ₖ)=cₖ.

We also have

<∇F(\overline{p}ₖ)−∇F(\overline{p}ₖ₊₁),\vec{D}ₖ≦∥∇F(\overline{p})−∇F(\overline{p}ₖ₊₁)∥·∥\vec{D}ₖ∥<∈.

This implies that ∥∇F(\overline{p}ₖ)∥=cₖ<∈. Hence \overline{p} is a critical point. □

Lemma 2 Suppose p≠p′ are both limit points of our iteration, Then they are both critical points.

Proof. It suffices to show that p is a critical point. For a sequence pₖ to have more than one limit point, for any r>0 there must be infinitely many of the Pₖ lying outside Bᵣ(p). Choose an r>0. Let us denote the points pₖ such that Pₖ₊₁ ∉ Bᵣ(p) by pₙ_{ₖ} since they form a subsequence of the original pₖ. It is easy to see that

$${lim}_{k \to ∞} {p}_{{n}_{k}} = p .$$

Let p :=(\overline{p},g(\overline{p})),V:={χ:(χ,g(χ)) ∈ U} and F(χ):=f(χ,g(χ)) in V. Assume that

∥∇F(p)∥=α>0.

(We will show this is impossible, which leads to a contradiction.)

We know that ∥∇F(·)∥ is continuous in V, there exist a₁ and V₁ such that α>α¹>0, V₁ ⊂ V, V₁ is compact and

∥∇F(χ)∥=α₁∀χ∈V.

Moreover, because ∥∇F(·)∥ is uniformly continuous in \overline{V}₁, there exist ∈>0 and δ>0 so that ∈<2α₁² and

∥∇F(χ)−∇F(y)∥<ε if χ,y ∈ V₁, |χ−y|<δ.

Since

$${lim}_{k \to ∞} {p}_{{n}_{k}} = p ,$$

there exist K>0, s>0 so that s<δ and

Bₛ(\overline{p}ₙ_{ₖ})⊂V₁, ∀k≧K.

Let Lₖdenote the ray through the point \overline{p}ₙ_{ₖ} with the direction ∇F(\overline{p}ₙ_{ₖ}), and let yₖ denote the intersection of Lₖ and ∂Bₛ(\overline{p}ₙ_{ₖ}). We claim that there exists B>0 so that

|F(yₖ)−F(\overline{p}ₙ_{ₖ})|>β, ∀k≧K. (18)

To show this, let θₖ be the angle between ∇F (\overline{p}ₙ_{ₖ}) and ∇F(yₖ). We show that there is

$${β}_{1} < \frac{π}{2}$$

such that θₖ<β₁.

Let M=max{∥∇F(χ)∥, χ∈ \overline{V}₁}. Consider the triangle with ∇F(\overline{p}ₙ_{ₖ}), ∇F(yₖ), and ∇F(yₖ)−∇F(\overline{p}ₙ_{ₖ}) for its sides. Now

$$\begin{matrix}cos {θ}_{k} = \frac{{‖ ∇ F ( {\overline{p}}_{{n}_{k}} ) ‖}^{2} + {‖ ∇ F ( {y}_{{}_{k}} ) ‖}^{2} - {‖ ∇ F ( {y}_{{}_{k}} ) - ∇ F ( {\overline{p}}_{{n}_{k}} ) ‖}^{2}}{2 {‖ ∇ F ( {\overline{p}}_{{n}_{k}} ) ‖}^{2} \cdot {‖ ∇ F ( {y}_{{}_{k}} ) ‖}^{2}} \\ > \frac{{α}_{1}^{2} + {α}_{1}^{2} - {ε}^{2}}{2 {M}^{2}} \\ > 0\end{matrix}$$

since ε<2α₁². Hence

$${θ}_{k} < {cos}^{- 1} \frac{2 {α}_{1}^{2} - {ε}^{2}}{2 {M}^{2}} := {β}_{1}$$

We have

$${β}_{1} < \frac{π}{2}$$

because

$$cos {β}_{1} = \frac{2 {α}_{1}^{2} - {ε}^{2}}{2 {M}^{2}} > 0.$$

In fact, this is also true if we replace yₖ by any point on the line segment between \overline{p}ₙ_{ₖ} and yₖ. Note that any point on this line segment can be expressed as

$$y = {\overline{p}}_{{n}_{k}} + t \frac{∇ F ( {\overline{p}}_{{n}_{k}} )}{‖ ∇ F ( {\overline{p}}_{{n}_{k}} ) ‖} , 0 \leq t \leq s .$$

0≦t≦s. And the directional derivative of F along ∇F(\overline{p}ₙ_{ₖ}) is <∇F, ∇F(\overline{p}ₙ_{ₖ})>. Therefore

$$\begin{matrix}\vert F ( {y}_{k} ) - F ( {\overline{p}}_{{n}_{k}} ) \vert = \vert {\int }_{0}^{s} ⟨ ∇ F ( y ) , \frac{∇ F ( {\overline{p}}_{{n}_{k}} )}{‖ ∇ F ( {\overline{p}}_{{n}_{k}} ) ‖} ⟩ ⅆ t \vert \\ \geq \vert {\int }_{0}^{s} ‖ ∇ F ( y ) ‖ \cdot 1 \cdot cos {β}_{1} ⅆ t \vert \\ \geq ( s \cdot {α}_{1} \cdot cos {β}_{1} ) := β \\ > 0.\end{matrix}$$

This is true for any k≧K. We have proved (3.6). Now we show that it implies F(\overline{p})=∞.

Recall in the beginning of our proof, \overline{p}ₙ_{ₖ} ∈ U [symbol] p₍ₙ_{ₖ}₎₊₁ ∉ U [symbol] \overline{p}₍ₙ_{ₖ}₎₊₁ ∉V. Thus

F(\overline{p}₍ₙ_{ₖ}₎₊₁)−F(\overline{p}ₙ_{ₖ})>F(yₖ)−F(\overline{p}ₙ_{ₖ})>β,

and this is true for all k≧K. Then

$$\begin{matrix}F ( \overline{p} ) = F ( {\overline{p}}_{nK} ) + {\sum }_{k = K}^{∞} ( F ( {\overline{p}}_{( {n}_{k} ) + 1} ) - F ( {\overline{p}}_{{n}_{k}} ) ) \\ \geq F ( {\overline{p}}_{nK} ) + {\sum }_{k = K}^{∞} β \\ = ∞ .\end{matrix}$$

But we know F is a continuous function on a compact set \overline{V}₁con taining \overline{p}. Thus F is bounded in \overline{V}₁, and F(\overline{p})<∞. This is a contradiction. The assumption ∥∇F(\overline{p})∥v=α>0 must be false. We conclude that ∥∇F(\overline{p})∥=0, and \overline{p} is a critical point. □

In this section, we discuss the case when singular iterates occur. Let w_{q}:=(χ_{q(1))}, . . . , χ_{q(m)}), where {q(j)}ⱼ₌₁^{m} is a choice of m numbers out of {1, . . . , n+m} such that q(1)<q(2)<. . . <q(m). Let

$$J ( φ , {w}_{q} ) = ( \begin{matrix}\frac{\partial {φ}_{1}}{\partial {x}_{q ( 1 )}} & ⋯ & \frac{\partial {φ}_{1}}{\partial {x}_{q ( m )}} \\ & ⋮ & \\ \frac{\partial {φ}_{m}}{\partial {x}_{q ( 1 )}} & ⋯ & \frac{\partial {φ}_{m}}{\partial {x}_{q ( m )}}\end{matrix} ) .$$

When a line search is applied in our algorithm, there might be cases that the search is approaching the boundary of V, namely ∂V. When this happens, the Jacobian det J(φ, W_{q}) is very close to zero. This will create a singularity in both methods, the Taylor series method and the ODE method. One natural way to avoid it is to set a threshold on |det J(φ,W_{q})|. Since we may assume that p is inside a compact domain V, we know det J(φ, w_{q}) is continuous on V, and there are at most

$$\frac{( n + m ) !}{n ! m !}$$

choices of w_{q}, we can find a τ>0 so that

$${\sum }_{{w}_{q}} {( det J ( φ , {w}_{q} ) )}^{2} < τ$$

for any point in V. Let

$$η := \sqrt{\frac{n ! m ! τ}{( n + m ) !}} .$$

Then for any point p ∈V, ∃w_{q} such that

|detJ(φ,w_{q})(p)|>η.

Now we can keep track of the size of |det J(φ, w_{q})(p)|, and make the iteration stop at p if |det J(φ, w_{q})(p)|<

$$\vert det J ( φ , {w}_{q} ) ( p ) \vert < \frac{1}{4} η ,$$

η, and call p a singular iterate. Then we choose another collection of variables, say w_{q*}, so that

|detJ(φ, w_{q*})(p)|>η,

apply the Implicit Function Theorem on w_{q*} and repeat the procedure.

Lemma 3 Suppose

$$p = {lim}_{n \to ∞} {p}_{n} ,$$

where pₙ is the limit point we get at the nth iterate. Also suppose that, for any neighborhood B of p, there are infinitely many singular iterates inside B. Then p is a critical point.

Proof: Suppose that

$$p = {lim}_{n \to ∞} {p}_{n} ,$$

where pₙ is the point we get at the nth iterate, and that for any neighborhood B of p there are infinitely many singular iterates inside B. Denote all singular iterates by Pₙ_{ₖ}, k=1, 2, . . . since they form a subsequence of pₙ. First we show that there is a K>0 such that p₍ₙ_{ₖ}₎₊₁ is a 1-dimensional optimum ∀k≧K.

Because pₙ_{ₖ} is a subsequence of pₙ, we have

$${lim}_{k \to ∞} {p}_{{n}_{k}} = p .$$

Thus for any δ>0, there exists a K so that

$${p}_{{n}_{k}} ∈ B ( p , \frac{δ}{2} ) , ∀ k \geq K . \qquad ( 19 )$$

Recall the definition of the determinant function:

$$det ( J ( φ , {w}_{q} ) ) ≡ {\sum }_{σ ∈ {P}_{m}} {( - 1 )}^{sgn ( σ )} {\prod }_{j = 1}^{m} \frac{\partial {φ}_{j}}{\partial {w}_{σ ( q ( j ) )}} ,$$

where Pₘ is the permutation group of {1, . . . , m}. On a compact domain V, we can assume that it is uniformly continuous. This implies that for any ε>0, there exists a δ_{q} so that

|det(J(φ, w_{q}))(χ)−det(J(φ,w_{q}))(y)|>εif |χ−y|>δ_{q}.

Since there are at most

$$\frac{( n + m ) !}{n ! m !}$$

choices of such w_{q}, we may choose

$$δ := {min}_{q} \{ {δ}_{q} \} .$$

Then for any ε>0, there is a δ>0 such that if |χ−y|<δ, then

|det(J(φ, w_{q}))(χ)−det(J(φ,w_{q}))(y)|<ε (20)

for any w_{q} of our choice.

Because Pₙ_{ₖ} is a singular point, we must choose another collection of variables, say w_{q*}, from (χ₁, . . . , xₙ₊ₘ) such that

det(J(φ, w_{q*}))(pₙ_{ₖ})|≧η, (21)

apply the Implicit Function Theorem and start the next iteration. Now choose

$$ε := \frac{1}{5} η .$$

Then there is a δ such that for any |χ−y|<δ we have (3.8). But we also know there is a K such that |pₙ_{ₖ}−p₍ₙ_{ₖ}₎₊₁|<δ∀k≧K since

$${lim}_{k \to ∞} {p}_{{n}_{k}} = p .$$

Therefore

$$\vert det ( J ( φ , {w}_{q *} ) ) ( {p}_{{n}_{k}} ) - det ( J ( φ , {w}_{q *} ) ) ( {p}_{( {n}_{k} ) + 1} ) \vert < ε = \frac{1}{5} η .$$

With the fact [3.9], we can get

$$\vert det ( J ( φ , {w}_{q *} ) ) ( {p}_{( {n}_{k} ) + 1} ) \vert > \frac{4}{5} η .$$

This violates the condition for pₙ_{ₖ}₊₁ to be singular. Hence it must be a 1-dimensional optimum. Then by the same argument as in the first Proposition is Section 4, we can show that ∥∇F(p)∥ is as small as we want, and hence p is a critical point. □

We solved six small equality constrained problems using both CCM and the fmincon routine in MATLAB 6.1. The CCM was also implemented on MATLAB. To determine the number of iterations performed by the fmincon routine, we increased the MaxIter environment variable—which sets an upper limit on the number of iterations in fmincon—until the optimization terminated successfully. The results are presented below.

| Problem | | |
|---|---|---|
| #1 | NLP | Initial point |
| 1. | max x² + (y − 2)² + z² s.t. 4x² + 36y² + 9z² − 36 = 0 xz − 4z = 0 | $( \frac{\sqrt{11}}{2} , \frac{5}{6} , 0 )$ |
| 2 | max −x² − y² − (z − 3)²s.t. x² + y² − z² + 1 = 0 | $( 1 , 1 , \sqrt{3} )$ |
| 3 | max 100x − 4xy² | (0, 10) |
| | s.t. x² + y² = 100 | |
| 4 | max −x⁶ − y⁶ | (0.9988, 0.05, |
| | s.t. x² − y² − cos z = 0 | 0.1) |
| | x² + 2xy + y² − sin z − 1 = 0 | |
| 5 | max −x² − y² | (0, 1) |
| | s.t. −e^{x} + y = 0 | |
| 6 | max e^{3x+4yx}s.t. x² + y² − 1 = 0 | $( - \frac{1}{2} , - \frac{\sqrt{3}}{2} )$ |

| | No. of iterations | | Solution | | |
|---|---|---|---|---|---|
| | | Matlab | | Matlab | |
| Prob. | CCM | (fmincon) | CCM | (fmincon) | Correct |
| 1 | 2 | 8 | (2.90, −0.25, 0) | (2.90, −0.25, 0) | (2.90, −0.25, 0) |
| 2 | 1 | 3 | (0.8, 0.8, 1.51) | (0.79, 0.79, 1.49) | (0.79, 0.79, 1.5) |
| 3 | 2 | ∞ | (−5, 8.7) | Optimization | (−5, 8.66) |
| | | | | terminated | |
| | | | | by Matlab | |
| 4 | 2 | 9 | (0.72, 0.72, 1.55) | (0.70, 0.70, 1.5708) | (0.70, 0.70, 1.57) |
| 5 | 1 | 4 | (−0.42, 0.65) | (−0.42, 0.65) | (−0.42, 0.65) |
| 6 | 2 | ∞ | (0.62, 0.78) | Terminated (by us) | (0.6, 0.8) |
| | | | | after 1000 | |
| | | | | iterations | |

As can be verified on MATLAB 6.1, the fmincon routine cannot solve equality constrained nonlinear programs 3 and 6 whereas our method yields a reasonably accurate solution within two iterations. The accuracy of the solution can be improved to desired levels by iterating further in CCM. We terminated the computation after two iterations to show that the method yields a considerably accurate approximation of the optimal solution after just two iterations.

1. A method for improving the computational efficiency of nonlinear optimization procedure, comprising the steps of:
(a) receiving a nonlinear surface, the nonlinear surface including a plurality of points, each of the plurality of pints including an associated value;
(b) receiving an objective function which associates to each of the plurality of points an objective function value;
(c) selecting one of the plurality of points to be a reference point; and
(d) maximizing the objective function value by the sub-steps of:
i. computing an improving direction, at the reference pint such that the associated value of a point in proximity to the reference point and on a line passing through the reference point in the improving direction is greater than the associated value of the reference point;
ii. computing a curve that lies entirely on the nonlinear surface such that the tangent to the curve at the reference pint coincides with the computed direction;
iii. determining the point along curve at which the objective function value attains a value higher than that at the reference point; and
iv. adjusting the reference point to be the pint resulting from the above determining step.

2. The method of claim 1, further comprising the step of repeating the maximizing step until no point exists at which the objective function value is greater than the associated value of the reference point.

3. The method of claim 2, wherein the objective function value is based on the plurality of points.

4. The method of claim 2, wherein the reference point is initially selected based on a random process.

5. A method for improving computational efficiency of a nonlinear optimization problem, comprising the steps of:
inputting a nonlinear program including a feasible point;
calculating at least one partial derivative;
determining the gradient direction from the summation of the at least one partial derivative;
performing a line search to find a one-dimensional local optimum by solving a system of ordinary differential equations;
implementing Taylor polynomial approximation and Newton's method to establish a critical point; and
outputting the critical point to satisfy the feasible point;

6. The method of claim 5, further comprising the step of defining a coordinate system that describes a local geometry.

7. The method of claim 5, further comprising the step of coordinating an arbitrary curved surface with overlapping coordinate patches.

8. The method of claim 6, wherein the coordinate system is a canonical coordinate system.
